(19) United States
(12) Patent Application Publication
(10) Pub. No.: US 2003/0162147 A1
(43) Pub. Date: Aug. 28, 2003

(54) Combination set of denture teeth units for setting-up dentures in balanced articulation

(76) Inventor: Frans A.B. Dequeker, Burwood (AU)

Correspondence Address: F. DEQUEKER, Dental Laboratorium, Applied science, research and technology, P.O. Box 144, Burwood 1805, N.S.W., 2134, AU

(21) Appl. No.: 10/321,541

(22) Filed: Dec. 18, 2002

(30) Foreign Application Priority Data
Feb. 25, 2002 (AU) PS/0695

(51) Int. Cl. A61C 13/00

(52) U.S. Cl. 433/167; 264/17

(57) ABSTRACT

A combination set (FIG. 1, A,B), at least in a medium size or different sizes, includes complete arched denture teeth units (1), (2) preformed without denture base, for setting up denture teeth instantly and adjustable in a full balanced articulation during custom denture work. The set(s) is composed of a complete upper (1) and separate complementary complete lower (2) arched denture teeth unit, each including anterior and posterior denture teeth inter-connected either in a complete (A) or under-extended complete (B) tooth arch at least in an oval form. Each of the units includes a total unitary inter-occlusal bite plane preformed in a corresponding centric occlusion and full balanced articulation.

In order to prevent to setting-up denture teeth, one by one in the centric and full balanced articulation, as regularly, hereto the unitary inter-occlusal bite plane is pre-set according to interconnected anterior and posterior denture teeth. While the posterior denture teeth are formed cuspless spheroellipsoidal, conforming a 4 inch (11 cm.) radius, thereby pre-set either in a planar or anterio-posterior or curved sphero-ellipsoidal arrangement including a free centric inter-occlusal contact (FIG. 2) either full (C, 5) or partly (D,6) and a free eccentric bi-lateral balanced articular contact. Having the last molar posterior denture teeth either broader or not than regularly and pre-set without tongue interference to ascertain individually the balanced articular contact. Having the set(s) non-bendable from a durable tooth aesthetic material. The invention includes further a method A for preforming the set(s) from the material by providing a durable economised mould structure and yet a method B for setting up the set(s) in an instant and adjustable full balanced articulation with the provision of an auxiliary set of tools.

### FIELD

The invention relates generally to a preformed combination complete set or sets of denture teeth interconnected in an arch form and without denture base and method for making and using the same. More particularly it is related to such type of set(s) specially suitable for setting up denture teeth productively with ease and directly in a non-interfering bi-lateral and protrusive balance articulation for a custom denture in use.

### BACKGROUND

For such activity of setting-up denture teeth of a conventional complete set(s) of separate individual denture teeth or units thereof, these teeth are often used from a dental supply stock. During practising of such specialised articulation, this is not always satisfactory, as it is recognised that in this instance the setting up is neither productive nor accurate by using the regular available sets of denture teeth or units.

The difficulty arises by setting up the separate denture teeth one by one in individual balance. In this instance there is a risk involved of loss of the position of these teeth due to the use of a bulk of dental wax heated and melted to attach the set-up denture teeth on a denture base, substantially either of dental wax or plastic conformed to it's respective endentulous jaw model, upper or lower.

During the hardening stage of the wax from hot to cold shrinkage occurs which leads to loss of occlusal balance form during the setting up of the teeth guided with a occlusal balance plate used for such balance setting-up.

Also a movement of the denture teeth relative to each other occurs during check-up of the balance by executing protrusive and bi-lateral excursions with the use of a balance dental articulator used for such set-ups, consequently the balanced articulation is distorted.

To readapt the articulation in balance fit again, by prying in the bulk of wax as in regular use, the same problem repeats as heretofore described. Or to readapt, by the regular technique of over excessive spot grinding, as known, using dental articulating paper and handpiece power tool either in the laboratory or in the mouth, is causing damage to the functional pre-designated balance design form of the denture teeth.

For instance, denture teeth according to the doctrine of Beresin-Beresin and the free centric and eccentric Centrimatic denture teeth and other types of denture teeth are characterizing a predesignated balanced design form, and would be damaged.

Further more the conventional industrial process for constructing a durable mould and using the mould for pre-manufacturing pre-formed complete sets either of separate individual denture teeth or sets of preformed arched denture teeth units, is demanding a high expenditure of costs.

Also the conventional methods of setting up these sets of separate teeth for establishing a full balanced non-interfering articulation are using a full or semi-adjustable balance dental articulator and the individual condyle path based technique of the temporo-mandibular joint of the human jaw complex. These methods are complex and cumbersome, particularly in countries with extreme or irregular climatic conditions.

Previous attempts to provide sets of preformed fully or partly arched denture teeth units to produce a regular articulation for custom denture work have had some disadvantages, and were not intended and able to resolve the outstanding problems of the background of present invention.

As the description goes on the difference of idea between the cited attempts and the present invention will be distinctly indicated during the further description of the present invention.

### THE OBJECTIVES OF THIS INVENTION

The general objective is based to avoid the difficulties arising in the background when setting up denture teeth in order to attain a productive and accurate result for a full balanced non-interfering articulation for customised denture work.

A primary objective is to provide a preformed combination set(s) of preset full balanced denture teeth, interconnected in arched units without denture base, and at least in one suitable size that can be modified in other sizes, or in a variety of three suitable sizes to comply with the different human jaw relations.

A secondary objective is to provide a durable mould structure which enables to provide the preformed complete combination set(s) of arched denture teeth units, without to be involved in the necessity of a high expenditure, for the structure and use of a conventional industrial mould structure.

A third objective is to provide a method for using the preformed combination set(s) of arched denture teeth units to create with ease and instantly a non-interfering full balanced articulation for custom denture work.

A fourth objective is to enable a single skilled trained dental technician, with the only assistance of an apprentice dental technician, to control at all times and to produce the non-interfering full balanced articulation for custom denture work. As well as to enable the technician to execute the specialised dental articulation without to be involved in the expenditure for high skilled team work of several high qualified dental technicians.

### THE GENERAL STATEMENT OR SUMMARY OF THE INVENTION

With the objectives in view, the difficulties of the background as defined, are addressed by the present invention. Hereto the invention provides a suitable consistent balance design form and construction thereof for a preformed combination set complete arched denture teeth units. Having the set at least in one suitable size or sizes, of pre-set full balanced denture teeth interconnected in complete arched units without denture base. Having the set(s) composed substantially of a complete arched upper denture teeth unit including anterior and cuspless sphero-ellipsoidal posterior denture teeth preset in a bi-lateral and protrusive unitary occlusal bite plane. Separately a complementary complete arched lower denture teeth unit including anterior and cuspless sphero-ellipsoidal posterior denture teeth preset in a unitary occlusal bite plane conformed in a full balance form-fit with the bite plane of the upper denture teeth unit. Having the occlusal bite plane of the denture teeth units respectively as a inter-occlusal bite plane, being sphero-ellipsoidal, either on a planar or curved level thereby including a free centric inter-occlusal contact and a free eccentric articular inter-balance contact either partly or full during articulation. Having the set(s) as non-bendable and form-stable substantially of a durable abrasion-, and colour-proof rigid aesthetic tooth material either of ceramic or ceramic composite. Having the set(s) preformed substantially, with a capability for an instant and accurate setting-up of denture teeth in a non-interfering, full balanced articulation during custom denture work. Finally the invention provides a method A for preforming the set(s) productively without high expenditure, and a method B for using the set(s) in a full consistent balanced articulation without an extra skilled complex technique.

### DETAILED DESCRIPTION OF THE PRESENT INVENTION

With the objectives in view and with reference to the accompanying drawings one preferred embodiment will now be described.

### BRIEF DESCRIPTION OF THE DRAWINGS

FIGS. 1 A, B is a top-plan view of a preformed combination set(s) (1),(2) either in a complete arch form, A, or in a under-extended complete arch form, B, shown as a separate item, thereby illustrating the corresponding inter-occlusal bite planes (3)(4) of the units in a bi-lateral and protrusive preset balance form, as made and used in method A and B of this invention.

FIGS. 2, C,D, is a side (proximal) view of the centric occlusal bite relation in the molar-premolar region of the upper and lower inter-occlusal bite plane of the arched denture teeth units of FIG. 1, thereby having the centric occlusal bite relation either in a structural form of a full occlusal “surface-to-surface” contact as shown in C, (5), or in a partly occlusal “edge-to-surface” contact, D, (6) as made and applied to method A and B of this invention.

FIG. 3, is a side view of a human jaw complex; thereby characterised with a curved temporo-mandibular joint structure (7) and separately slowing the complementary curved condyle path movement (8) of this jaw complex showing the jaw complex fitted with a upper and lower denture including the combination set, designed with a planar inter-occlusal bite plane, causing a separation indicated by the mark (<) FIG. 3 of the inter-occlusal bite plane. (3)(4), consequently a loss of fit and balanced articulation of the upper and lower denture teeth of the set of a custom denture including the units (1),(2) in the mouth.

FIG. 4, is a cross-sectional side view of a simplified universal balance dental articulator (10) comprising a horizontal (11) and a curved sphero-ellipsoidal articulator joint (12) functionally designed to imitate the basic movements of the human jaw-complex either with a planar or curved condyle path movement of the temporo-mandibular joint of the human jaw complex, thereby used to set-up either separate denture teeth or the interconnected denture teeth units according to the design, FIGS. 1, A,B in a non-interfering balanced articulation as applied in method A and B of this invention.

FIG. 5, is a cross-sectional side view of a supplementary-auxiliary balance instrumentarium (13) including an adjustable releasable-fixing telescopic occlusal guide (14) and separately in exploded view a releasable-fixing sphero-ellipsoidal curved (15) and planar (16) occlusal guide plate as used in method A, B, of this invention.

FIGS. 6,E,F is a cross-sectional side view of the anterior section, E, of the upper denture teeth unit of FIG. 1. A on the line a-a, showing the layering structure of the ceramic-composite material used as the material of choice for the combination set(s) denture teeth units of FIGS. 1,A,B as made and used in method A and B of this invention; thereby a cross-sectional side view of the posterior section F, of the upper denture teeth unit of FIG. 1.A on the line b-b, showing the layering structure of the ceramic-composite material.

FIGS. 7, G,H, is a cross-sectional view on the line a-a of the unit 1, FIGS. 1, A/B including a regular custom denture base, G, of thin acrylic plastics, which includes a metallic reinforcement (17)(18) substantially of 2-3 twisted wires, of titanium or super alloyed steel, about 1.2 mm. Ø or substantially of a grid bar 1.5 mm. thick located either in the labial, or in the palatal region or in both of the denture base; in case of an immediate custom denture base, H, the base includes said metallic reinforcement (17) as an extra reinforcement in the alveolar ridge region and in the palatal region for an immediate custom denture.

In an initial aspect of the present invention, there is provided a preset balance design-form for a preformed combination set of complete arched denture teeth units, upper and lower without denture base. Thereby having the set substantially at least in a medium size or in a variety of sizes related to the human jaw complex relation.

With the objectives in view and use of the set(s), the invention aims to render a capability for an instant, adjustable and accurate setting-up of denture teeth in a non-interfering, consistent full balance articulation during complete and partial bilateral upper and lower free-end custom denture work. By the phrase “full balance articulation” what is meant: total individual consistent balance during a bilateral movement and a combined protrusive movement of the lower jaw.

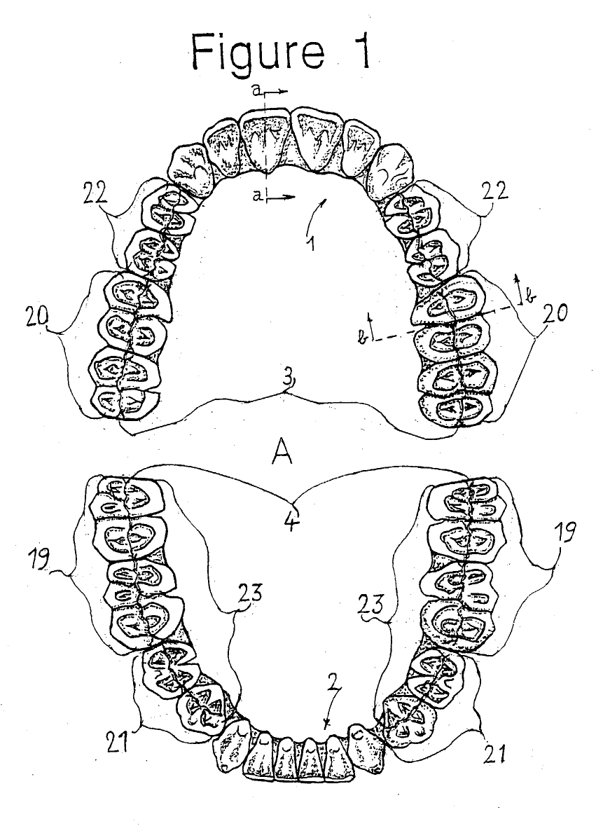

As disclosed in FIGS. 1, A, B, the set(s) is preformed in a composition of a complete upper denture teeth unit (1), indicated by an arrow, and in a composition of a complementary complete lower denture teeth unit (2), indicated by an arrow, and each unit being in an arch-form about 12 mm occluso-gingival height.

As one example, the upper denture teeth unit (1) includes interconnected anterior denture teeth and interconnected cuspless sphero-ellipsoidal posterior denture teeth preset in a centric occlusal relation and in a bi-lateral and protrusive balanced unitary occlusal bite plane (3). Thereby the lower denture teeth unit (2) includes interconnected anterior denture teeth and interconnected cuspless sphero-ellipsoidal posterior denture teeth preset in a unitary occlusal bite plane (4) conformed in a centric and balance form-fit in accordance with the occlusal bite plane (3) of the upper denture teeth unit.

As disclosed in FIGS. 1 A,B, having each respective one of the unitary occlusal bite planes (3) and (4) of the denture teeth units (1), (2), as an inter-occlusal bite plane, being either planar sphero-ellipsoidal or curved sphero-ellipsoidal. Thereby having the inter-occlusal bite plane including either a free full C, (5) or partly D, (6) centric inter-occlusal bite contact and a free eccentric partly balanced articular bite contact, not shown.

As further disclosed in FIGS. 1, A, B, the molar regions (19), (19) of the occlusal bite plane of the lower denture teeth unit (2) and the molar regions (20), (20) of the occlusal bite plane of the upper denture teeth unit (1), these regions may be broader in design form, although without tongue interference, than the lower (21),(21) and upper (22), (22) premolar regions of the set(s) of present units as shown, and broader without tongue interference than the molar and pre-molar regions of a conventional complete set of upper and lower denture teeth. It is contemplated that at least one or both denture teeth units (1), (2) are applicable to above molar principle.

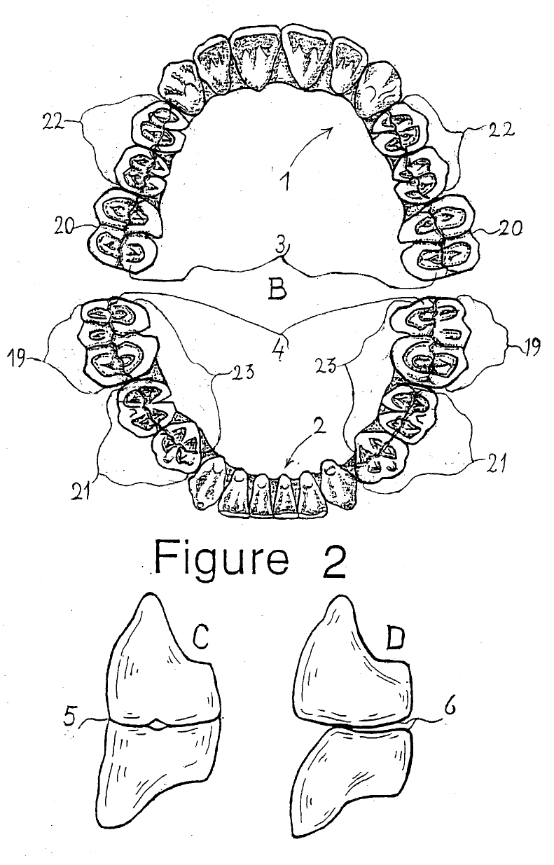

In a case whereby the inter-occlusal bite plane of the posterior denture teeth is in a design-form ‘edge-to-surface’, as a partly inter-occlusal contact, FIG. 2, (6) D, as specified in accordance with the Centrimatic articulation doctrine and with the Australian Pat. No AU-B1474/95 (Addition to the Main AU-B642892), in these instances either the upper molar region (20)(20) or the lower molar region (19)(19) is applicable to the broader molar principle as defined heretofore and detailed later in the method A for providing the units (1), (2).

The broader design form of the inter-occlusal bite plane (3),(4) of the molars (19),(19) and (20),(20) is another element of present invention to ascertain the consistent stability of the bi-lateral balance articulation during the eccentric articular inter-occlusal balance bite contact, as specified heretofore in the description, when executed on a human jaw complex characterising a flailing or extra larger temporo-mandibular joint structure, and articular function thereof.

As disclosed further in FIGS. 1, A, B there is shown at the left and right lingual sites (23) (23) of the molar (19)(19)-premolar (21)(21) regions of the lower denture unit (2) that the continuous lingual design-form of these sites is based on the principle to comply with the known “Pound's dental rule by having the lingual aspect of the regions out of the vicinity of the tongue in order to avoid lift-up of a lower denture due to interference of the tongue when the full lower denture is in use.

Further it is recognised in dental practice, that the posterior region of the alveolar ridge of the human jaw complex is characterised with a course either in a regular or in an irregular level. Having this level included of anatomical land marks, such as steep inclines located either anterior to the left and right retromolar pad of the lower jaw, or anterior to the left and right tuberosity pad of the upper jaw.

These landmarks as described are impeding the setting-up of the units (1)(2), firstly in order to establish the inter-occlusal bite plane (3)(4) in centric occlusion; secondly to execute instantly the full balanced articulation, as pursued, with the provision and use of the units (1), (2), as predetermined in the initial aspect of present invention, characterising an occluso-gingival height of 12 mm. and extra molar width as specified heretofore.

In these instances in order to achieve easily the specific full instant balanced articulation of present invention, the arch form of the combination set(s) is predetermined either in a complete extended tooth arch size as disclosed in FIG. 1, A, or in an under-extended complete tooth arch size, as disclosed in FIG. 1, B, whereby the last left and right posterior denture tooth, in terms and function as second molars, are excluded from each unit

The specific full balanced articulation, as aimed initially in the invention, is achieved with the use of the denture teeth units (1), (2), pre-designed with the occlusal-gingival height about 12 mm. and preferably with the extra molar width without tongue interference as defined heretofore, and with the difference of tooth arch form extension A, B, FIG. 1 of the combination set(s) denture teeth units. In these instances, the difference related to the tooth arch form size A, B, and height of each respective one of the units (1), (2), is pursued:

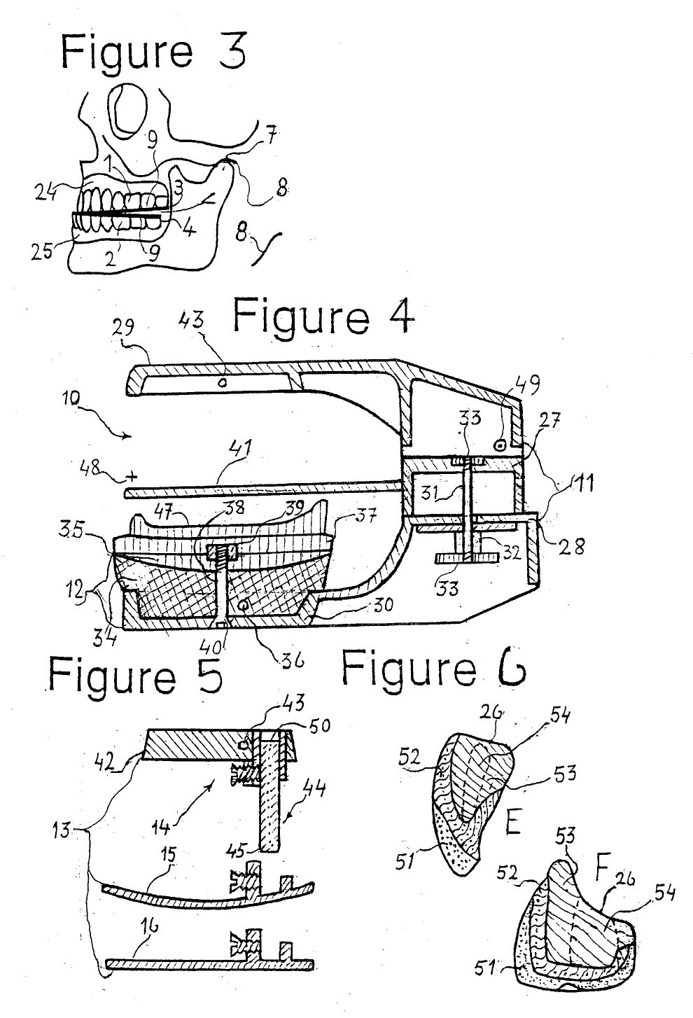

i) on the one hand to enable an individual fit of the units (1), (2) whereby their base is respectively conformed in fit on a stable upper (24) and lower (25) denture base, as disclosed in FIG. 3 and used as a total bite block base, to set up each respective one of the units, thereby performed by using a method A and B as specified in the later stage of present invention;

ii) on the other hand to enable to establish the inter-occlusal bite plane (3), of the upper unit (1) and the inter-occlusal bite-plane (4) of the lower unit (2) in a mutual corresponding inter-occlusal free centric occlusion and meanwhile in a free eccentric instant and adjustable full balanced articulation; thereby

having the articulation on a sphero-ellipsoidal planar level or on a sphero-ellipsoidal curved level, dependable of the heretofore defined individual path of movement (8) of the temporo-mandibular joint (7) of the human jaw FIG. 3, as performed by using the method A and B as disclosed later; thereby

in case of the curved level, having this level at least conformed to a 4 inch (11 cm.) radius of a sphere.

Note: The applicant is aware that prior art attempts have been made either to use full arched denture teeth units, such as related to the invention U.S. Pat. No. 2,768,440 or to use sectional units (posterior and anterior) related to the invention U.S. Pat. No. 4,437,0421, and all, in order to set up denture teeth in a regular centric occlusion. However these attempts were without consideration for a full instant non-interfering consistent balanced articulation for custom denture work. Thereby these attempts were practising a technique of bending the units in place, either by heat or by moving denture teeth, mounted on a flexible plastic strip or wire, in a desired position relative to each other with the purpose to conform the denture teeth base to a plaster jaw model complex. This technique as heretofore, was not possible in most individual cases to establish instant full balanced evenly levelled planar or curved articulation. While the regular conventional technique, including modifying the shape of the units by over excessive grinding, was causing to make the units weak.

In these instances it was not previously recognised that attributes of the kind of arch design form of present invention made it particularly useful for other dental techniques such as to create an instant and adjustable non-interfering full balanced articulation with the use of preformed full arched denture teeth units (1), (2) and executed with the methods A, and B, as detailed in a later description of the present invention.

Also to comply further the setting-up of the combination set (1),(2) A,B individually in the full balanced articulation, as disclosed in the foregoing description, in this instance at least the set night be provided as a standard set in one suitable tooth arch size, such as a medium size, that conforms the most commonly appearing medium arch size of the alveolar ridge of the individual endentulous human jaw complex upper and lower to be restored. Thereby having the standard set(s) further at least in an ovoid arch configuration, in a middle age tooth colour such as a greyish-yellow shade, and in a tapered shape for the anterior denture teeth arranged in a natural appearance conforming to the most appearing anterior tooth arrangement in human dentition.

As an exemplification: during the setting-up of the preformed standard medium size combination set(s) denture teeth as defined heretofore, this set(s) might be altered in a smaller, or larger size, which might be the case. Having the units which are in use, further separated in three sections, including a section of the interconnected anterior teeth, and a left and right section of the interconnected posterior denture teeth, thereby to be set up in accordance with the method B, disclosed in the latter stage of the invention.

Further for instance, in a case where the standard set is transformed in a smaller size:

the units (1), (2), of the set B, FIG. 1 are divided in 3 sections as defined heretofore;

thereby the first premolar of the left and right posterior tooth section of each unit is either removed or not;

the separated sections are further set-up in the balance articulation using the method B as stated in an other aspect of present invention: as a cardinal rule

during transforming in the size of choice, the left and right molar of each unit (1), (2) when using the standard set B, FIG. 1, are never removed in order to ascertain consistent bi-lateral balance in accordance with the individual joint structure of the jaw complex, which may have an irregular anatomical condition and function thereof.

It might be further contemplated to provide the combination set(s) (1) (2), A,B, FIG. 1, preformed in a variety of standard sizes such as: small, medium, large with the aim:

(i) at the one hand, having the variety combination sets of standard tooth arch sizes as an alternative provision readily to use any suitable desired size set units (1), (2) that enables to set readily the units instantly and adjustable in the full balanced articulation instead of previous technique using the standard combination set characterised in one medium tooth arch size;

(ii) at the other hand, having the variety combination sets of standard tooth arch sizes as an alternative provision to comply the setting-ups of denture teeth units (1), (2) individually in full balanced articulation adaptable to the situation of a variety of jaw and bite relations occurring in nature and classified according to 3 different classes of jaw relations I, II, III;

hereto using a technique of combining and relating the units (1), (2) with each other of the combination sets including a variety of standard tooth arch sizes;

further setting up the desired size by use of the method B as pre-designated in a later stage of present invention.

In that concern of the foregoing provision of the variety combination sets complete arched denture teeth units, while the setting-up techniques of the cited prior art inventions of arched tooth units are using their set denture teeth units in a variety of standard sizes only with the idea to conform the setting-up more or less readily with the different forms of jaw existing in nature, such as small, medium and large.

In this instance it was not recognised that attributes of the kind of the provision, as the present disclosed variety tooth arch sizes, for the combination sets denture teeth units, made it particularly useful for other dental techniques, such as to create an instant, accurate and adjustable non-interfering consistent full balance articulation with the use of the sets in the variety of sizes. Thereby having the set(s) preset in a balanced articulation to accommodate the situation of jaw relations in nature classified according to classes of different jaw relations I, II, III.

As heretofore disclosed in the total description, the combination complete set(s), FIG., 1, (1),(2), A,B, denture teeth units are preformed substantially of a durable abrasion-, form-bend-, and colour-proof aesthetic tooth material such as dental ceramic or a derivative thereof substantially as a suitable light or dual light-self curable composite dental material, combined (or not) with a self-curable hard rigid ethyl meth-acrylic designed for bonding strength and impact resistance of the units, (1),(2) when used to the denture base of acrylic denture work.

Besides each tooth arch form size is at least in an oval configuration, in one colour most common in nature related to a middle human age, such as greyish-yellow. Further preformed with posterior and anterior denture teeth. Having the anterior denture teeth characterised with an outer aspect at least in one natural tapered form, preferably trapezoid, which maybe adjusted into an oval or square, or triangle, or combined form.

Thereof, either of the ceramic tooth materials include the capability to be formed with a mechanical retentive shape as a durable joining aid to be applied to denture base materials of various plastics during custom denture work.

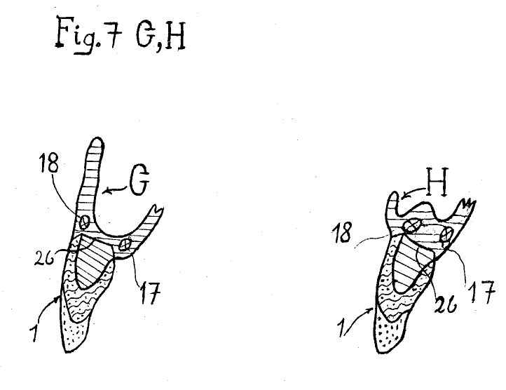

In the case of using the light curable ceramic-composite material, combined with said self-curable ethyl-methacrylate and formed partly as the unitary ridge lap base of the combination set(s) denture teeth, as disclosed in FIG. 6, E, F (26), in this instance the combined materials include the capability to be formed with a durable chemical bonding shape, and impact resistance to the set (1),(2), FIG. 1, A, B, when used to denture base materials of acrylic plastics and other during custom denture work.

In another aspect of present invention, there is provided a method A for preforming productively in a suitable mould structure combination set(s) of complete arched denture teeth units (1)(2), A, B, FIG. 1 as disclosed in the initial aspect of present invention.

Thereto, the method A is led in a, ‘Phase 1’, to initiate a prototype model complex in art plaster, substantially as a replica of the design-form as disclosed initially for the combination set(s); (1) (2). Having ‘Phase 1’, including steps and sub-steps thereof to be illustrated as an exemplification:

1. providing a jaw model complex including an upper and lower jaw model of plaster each pre-determined with a suitable height preferably of 20 mm. thereby substantially as a replica of a natural endentulous human jaw complex at least in a medium size or other sizes, featuring a temporo-mandibular joint (7) formed either with a curved (8) or planar condyle (lower jaw bone) path movement as disclosed in FIG. 3;

2. forming on the jaw model complex a bite-block complex, upper and lower block, which is further recorded orally in centric occlusion predetermined with a height of 40 mm., a suitable measurement to accommodate the internal height of a universal balance dental articulator (10) provided and predetermined during the development of the steps of the present method A, for setting up a complete combination set(s) denture teeth in a full balanced articulation;

3. as disclosed in FIG. 4, custom building the dental articulator (10) preferably with an internal height of 110 mm or more and constructed from impact resistant engineering plastics or aluminium anodised or coated with plastics; thereby

composing the articulator with a universal articulator joint constructed substantially of a combination including a horizontal planar articular joint (11) substantially as a releasable fixture and integrated part of the articulator and a sphero-ellipsoidal curved articular joint (12) substantially either as a integrated part or separate releasable fixture of the articulator; thereby

having the horizontal planar articular joint (11) devised with an upper (27) and complementary lower (28) planar articular block, thereby having the upper articular planar block (27) in conjunction with a hinged laterally and horizontally extended upper tray member (29) and the lower articular planar block (28) in conjunction with a laterally and horizontally extended lower tray member (30);

having both articular planar blocks (27) (28) joined horizontally onto each other in even contact by means of a center hole (31) (32) channelled respectively in each block (27)(28) respectively and a releasable fixing bolt-nut device (33);

having both tray members (29)(30) parallel aligned with each other at a distance including the predetermined internal height of at least 110 mm.;

in the case of releasing the bolt-nut devise, the joint (11) allows a horizontal sliding and rotary movement, aiming to execute and imitate the movements of the human jaw complex when characterised with a planar condyle path movement; thereof

having the horizontal articular joint (11) further in combination with the releasable-fixing curved sphero-ellipsoidal articular joint (12) of a sphero-ellipsoidal cross section, conformed at least to a 4 inch or 11 cm. radius of a sphere;

having the curved articular joint (12) substantially custom formed, as a releasable fixture to be separately mountable as a part of the articulator (10) thereby consisting of 2 curved articular blocks a lower (34) and an upper (35), having the lower curved articular block (34) substantially either as a separate releasable fixture or integrated part of the articulator and made of stone plaster or aluminium or plastic or combination thereof; thereby

the lower curved articular block (34) is joined with a cross pin (36) on the lower tray member (30);

having the curved upper articular block (35) substantially as a part of the lower jaw model base (37) custom formed from dental stone plaster on top of the curved lower articular block (34) during the fixing and recording of the upper and lower jaw model complex in centric occlusion by means of the orally registered bite-block complex on the articulator of step •2;

having both blocks (34)(35) joined together thereby substantially in a sphero ellipsoidal cross section conformed to a 4 inch (11 cm.) radius of a sphere and relatively on each other, by means of a center hole (38) channelled in each articular block and the lower tray member (30); further

having the both blocks (34) (35) releasable-fixing with a releasable-fixing bolt-nut device (40) (39);

in case of releasing the device (40),(39) the joint (12) allows a sphero-ellipsoidal sliding and rotary movement able to execute and imitate the movement of the human lower jaw when characterised with a curved average condyle path movement (8);

Note: It might be stated that the applicant takes the advantage to exploit the physiological flexibility of the temporo mandibular joint of the human jaw complex to provide and use a simplified movable universal dental articulator joint, pursued for creating individual full balanced articulated denture work

Thereof, the combination of the articular joints (11),(12) of the universal balance dental articulator accommodate the capability to let execute the function of the individual human joint of the jaw, and is part of the invention.

Meanwhile the simplified universal joint structure offers the advantage in order to avoid the high expenditure of costs and cumbersome complex technique of a balance dental articulator engineered to be fully or semi-adjustable to the function of the individual condyle path movements of the temporo-mandibular joint (7) of the human jaw complex.

4. providing an auxiliary balance instrumentarium (13) complementary for use with the articulator including:

a planar plate (41) releasable-attachable and horizontally mountable on the articulator (10);

as disclosed in FIG. 5, custom devising a balance instrumentarium (13) made of plastic or metal substantially as a guide tool for guiding and forming the inter-occlusal bite plane (3)(4), either planar or curved in a complete arch form during the setting-up of the complete combination set(s) denture teeth (1),(2) either separate or interconnected in complete arch form; hereto

devising a telescopic occlusal guide (14), with a releasable-fixing base (42) complementary to the articulator and to be suspended vertically and fixed with a cross-pin (43) onto the upper tray member (29) of the articulator (10); further

devising the base (42) with a vertically adjustable telescopic sliding arbor (44) complementary to the occlusal guide and substantially of a non-rotary cross-section, and having this arbor (44) at least substantially of a length including 40 mm. and 70 mm.;

having the 40 mm. arbor length as a suitable measurement to support releasable fixing a planar or curved occlusal guide plate for the formation of the inter-occlusal bite-plane (3), (4) respectively;

while the 70 mm. arbor length is predetermined for the establishment of the curved lower articular block (32) for the establishment of the curved articular joint (12), thereby having each arbor length (44) in coordination to accommodate the internal height of 110 mm. of the articulator (10); further

devising each arbor (44), substantially either of the 40 mm and 70 mm length respectively with the upper end (50), fitted and releasable fixing on the base (42), and with the lower end (45) either onto the planar occlusal guide plate (16) or the curved occlusal guide plate (15), conformed to a curve of 4 inch (11 cm) radius of a sphere; further

using the arbor, which is predetermined with a length of 40 mm. to join either of the occlusal guide plates, as an aid for guiding and forming the upper and lower inter-occlusal bite planes (3),(4) during the settings up of the combination set(s) denture teeth either separated or interconnected in a complete arch form; hereto

having the curved as well as the planar occlusal guide plate, for an initial setting-up of the lower denture teeth of the complete combination set(s) denture teeth, in a similar position, thereby parallel and horizontally aligned with, but at a suitable distance from, the lower jaw model (47) joined with the curved upper articular joint (35), of the curved articular joint (12) fixed together but releasable with a bolt-nut device (40)(39), on the lower tray member (30).

using either the planar (16) or curved (15) occlusal guide plate releasable-fixing with a set screw onto the lower end of the arbor (45) which enables to establish individually the inter-occlusal bite planes (3),(4) respectively of the setting up of the combination set(s) characterised either with a planar or curved bite plane form which is conformed at least to a 4 inch (11 cm.) radius of a sphere; while

using the arbor, which is predetermined with a length of 70 mm, as an aid to pre-construct the lower curved articular block (28), as an initial part of the curved articular joint (12); hereto

using an other similar curved occlusal guide plate (15), which is fixed but releasable with a set screw on the lower arbor end (45) of 70 mm. length, mounted on the occlusal guide base in order to position horizontally the occlusal guide plate (15) onto the top of the lower tray member (30) of the articulator for the formation of the curved lower articular block (34) either as an integrated or as a separate releasable-fixing part of the articulator, during completing of the curved articular joint (12); thereby completing the curved articular joint (12) with a complementary curved upper articular block (35) custom formed during the fixing of the jaw model complex: bite-block complex as an assembly to fix and record the jaw model complex in centric occlusion and in level on the articulator (10); besides

5. in order to establish the centric occlusion before the establishment of the balanced articulation of the setting up of the combination set denture teeth upper and lower in the articulator; hereto

having the bite-block complex of step •2 provided with an upper and lower wax occlusal rim, each including a 17-18 mm. height predetermined to execute a orally registered bite-block thereof, including a maximum height of 34-40 mm, as a suitable measurement to accommodate the internal height of 110 mm. of the articulator (10);

providing at least an adjustable wall shelf or preferably a tower dental working bench devised with adjustable shelves predetermined to be adjusted at the level of the desired individual eye sight for ease and accuracy and productivity of executing further steps on the articulator, according to the methods A,B as disclosed in a later stage of present invention; hereto

using and fixing the orally registered bite-block complex including the jaw model complex as defined heretofore, in centric occlusion on the articulator; thereby

using the releasable-attachable planar mounting plate (40) on the articulator (10) for positioning in level and releasable fixing the orally registered bite recording block complex including the jaw model complex, as an assembly for fixing the jaw model complex in centric occlusion on the articulator, thereby using a regular technique according to the established horizontal occlusion and articulation for a setting-up of denture teeth; hereto

executing the position of the orally registered bite-block complex: jaw-model complex by using a center-cross line (48) marked anteriorly on the mounting plate (41) as known: firstly locating the mid of the separate upper bite block, marked with a center line and joined with the upper jaw model, to the center of the cross line (48) on the mounting plate (41); simultaneously

releasable-fixing, by using plaster and a cross-pin (43), this upper jaw model with its base onto the upper tray member (29); thereby

removing the plate (41) and reversing the articulator and positioning the lower bite block including the lower jaw model (47) upside down, using guide lines previously recorded on the occlusal wax bite rims of the blocks, enabling to fix the jaw model complex in a centric bite position on the articulator;

in case, of a setting up of the combination set denture teeth according to a curved inter-occlusal bite-plane hereto releasable fixing the curved lower articular block (34) of the curved articular joint (12), using the cross-pin (36) and plaster on the lower tray member (30);

using a release agent and coating the top surface of the lower articular block (34) of the curved articular joint (12) exposed with its top surface and the nut (39) of its bolt-nut device (40)(39):

in case of a setting up of the combination set teeth including a planar inter-occlusal bite-plane, hereto releasable-fixing the lower jaw model directly on the lower tray member (30) using a cross-pin (36) and plaster, and in this instance without the curved articular joint (12); alternatively

fixing the lower jaw model consistently in a static condition onto the curved lower articular joint (34) and lower tray member (30) using the bolt-nut (40) (39) and plaster;

for either of the setting-up cases, as heretofore stated during the fixing of the lower jaw model on the tray member of the articulator, using a layer of dental stone plaster on the surface of the base (37) of the lower jaw model (47) which has remained in centric occlusal relation with the bite-block complex and the upper jaw model fixed with the releasable-fixing cross-pin (36) on the articulator (10) used in an open position with the hinge (49) of the upper tray member (29);

closing the articulator (10) exactly by placing the lower tray member (30) downwardly; simultaneously

using the horizontal articular joint (11), to control exactly the closure of the universal balance dental articulator, whereby the planar articular blocks (27),(28) are meeting each other in a mutual contact and level; further

during the custom forming of the curved articular block (35), having the nut (39) of the bolt-nut device (40),(39) embedded, herewith completing the curved articular joint (12);

Note: relative to step •5 and sub-steps thereof it will be indicated that the horizontal articular joint (11), includes a triple function predetermined: by control of the exact closure of the universal balance dental articulator, whereby the planar articular blocks (27), (28), of the horizontal articular joint (11), are meeting each other in a planar and horizontal level, thereby applicable;

firstly for and during the establishment of the curved articular joint (12);

secondly for and during the fixing and recording of the upper and lower jaw model complex in centric occlusion by use of the orally registered bite-block complex on the articulator (10);

thirdly for and during the checking and adjustment for the establishment of a non-interfering centric occlusion and full balanced articulation thereof for either of the setting-ups of the combination set(s) of denture teeth characterised with a planar or a curved inter occlusal bite-plane (3) (4) and achieved on the universal balance dental articulator (10);

the method for control and establishment of the horizontal joint (11) during use of the articulator (10) for the setting-ups, is part of the invention.

6. setting-up two complete combination sets of separate denture teeth one by one and according to the design form of each individual tooth of the pursued preformed combination set(s) denture teeth (1)(2) A or B, FIG. 1, thereby in full balanced articulation; hereto

removing the upper jaw model, including the upper bite block, from the upper tray member (29) by using the releasable-fixing cross-pin (43) as disclosed in FIG. 4;

using the arbor of 40 mm. length (44) of the occlusal guide (14) and which is fixed but releasable with the upper end (50) on the base (42) of the occlusal guide (14) which is further fixed but releasable on the vacant upper tray member (29) by means of its cross-pin (43); thereby

releasable-fixing of either of the occlusal guide plates (16),(15), on the lower free-end (45) of the arbor (44), thereby for the setting-up of the complete combination sets separate denture teeth destined with a planar inter-occlusal bite plane using the planar occlusal guide plate (16), while for the setting-up with a curved inter-occlusal bite plane using the curved occlusal guide plate (15); further

for either of the setting-ups, using the telescopic arbor (44), including the destined occlusal guide plate, in order to suspend, position and hold this plate at a suitable overhead distance of 2-3 mm. from the lower bite block, remained mountable, according to the initial centric occlusal stand, on its lower jaw-model (47) which is fixed but releasable on its lower tray member (30) of the articulator (10), further;

removing the wax occlusal bite rim from the lower bite block base leaving a free-way space of at least 10-12 mm. between the under surface of either of the occlusal guide plates in use and the bite block base; thereby

having the free-way space defined before the region of the bite-block base which covers the left and right retro-molar pad including any steep incline of the crest of the alveolar ridge anterior to the reunion of said pad marked previously on the bite block base: thereby

if required adjusting the telescopic arbor (44) at a higher level to render a sufficient free-way space for the establishment of the inter-occlusal bite-plane either in the planar or curved form and simultaneously having either of the bite plane forms in a horizontal level;

Note:

The above sub-step for a free way space avoids the conventional technique step of adjusting to establish a non-interfering centric occlusion and balanced articulation thereof by grinding either the ridge lap base or the inter-occlusal bite surface of the denture teeth which makes the denture teeth weak and the inter-occlusal bite-plane of the denture teeth inaccurate for balance and is part of the invention.

7. providing and reforming at least 2 available complete sets of separate upper and lower denture teeth, made of a good quality plastics preferably acrylic and of a medium size at least of 11 mm. height, thereby having each set composed of separate anterior denture teeth characterised preferably with a tapered trapezoid labial form, and further a set of separate posterior denture teeth characterised with a cuspless sphero-ellipsoidal curved occlusal surface form which conforms to the radius of a four inch (11 cm.) of a sphere; thereby

using a self-cure acrylic plastic to modify the occlusal form and buccal form of the upper and lower posterior denture teeth in a broader buccal-lingual and buccal-palatal, design form as described in the initial aspect of present invention and disclosed in (1)(2) A,B of FIG. 1 of the drawing;

8. using the 2 complete combination sets of separate upper and lower denture teeth as mentioned heretofore in order to establish 2 complete setting-ups respectively with these sets: having one setting-up according to a planar and the other setting-up according to a curved inter-occlusal bite plane conformed at least to a 4 inch (11 cm) of a radius of a sphere and having both setting-ups in an oval arch form; thereby

having at least each posterior bite-plane form or total inter occlusal bite-plane form (3),(4) in a sphero-ellipsoidal cross-section (conformed to a 4 inch (11 cm) radius of a sphere), and having each setting-up at least in an exact free centric occlusion, eg. with a full occlusal contact as disclosed in FIG. 2, C, (5), or partly occlusal contact as disclosed in FIG. 2, D, (6) and in a full balanced articulation to be used as the present example;

having any of the levelled inter-occlusal bite-planes, if required, further occlusally adjusted in a full (bi-lateral and protrusive) non-interfering balanced articulation; hereto

using a technique achieved by spot grinding with articulating paper or liquid or powder;

having either of the setting-ups proceeded initially with the lower set denture teeth executed according to a regular or desired technique which is suitable with the use of the suitable auxiliary aid instrumentarium including the mounting plate and the simplified universal balance articulator, and complementary balance instrumentarium (13), as defined in step •4; as an exemplification

9. Using a suitable technique for setting up initially the lower separate denture teeth, for either of the complete setting-ups of the combination sets separate denture teeth, thereby having one setting-up according to a planar and the other setting-up according to a curved level, which may be performed according to the following sub-steps:

a. initially using the telescopic occlusal guide (14) including the arbor length of 40 mm. and provided with either of the occlusal guide plates (14) or (15), and mounted on the upper tray member (29), thereby using preferably the sub-steps of step •6;

b. setting-up the lower denture teeth of either of the sets in use thereby one by one on the lower bite-block base;

c. having the ridge-lap base of each tooth on or before the course of the crest line of the alveolar ridge, marked previously on the surface of the bite-block base; simultaneously

d. having the occlusal surface of each tooth one by one at least arranged in an oval arch form thereby in an exact contact with the under surface of the occlusal guide plate in use (15) or (16) including the occlusal guide (14);

e. having the setting-up limited anteriorly to the region of the bite-block base which covers the left and right retro-molar pad, including any steep alveolar ridge incline of the lower jaw model and marked previously on the surface of the bite block base; thereby

f. limited lingually according to the known “Pound's” anatomical dental line, by setting-up the lingual aspect of the posterior denture teeth in a way to exclude any interference to the tongue; further

g. securing each tooth on the lower bite-block base, using preheated dental sticky wax;

h. contouring the lower denture base, using modeling dental wax, around the junction tooth and base; further

10. In order to set up the upper separate denture teeth for either of the complete setting-ups of the combination sets of separate denture teeth, whereby one setting-up is proceeded according to a planar and the other setting-up according to a curved level, hereto further sub-steps are performed;

from the upper tray member (29) removing the adjustable telescopic occlusal guide (14) in order to fix the upper jaw model with the mountable upper bite-block base, used as a finalised plastic denture base, on the vacant upper tray member (29), using thereby the releasable-fixing cross pin (43);

using the upper set denture teeth of the complete combination set denture teeth either by setting up the anterior teeth in a incisal ‘edge-to-edge’ centric occlusal contact relative to the lower anterior teeth; or

by setting up the anterior teeth in the centric occlusion with an extra horizontal over-jet of 2 to 3 mm. away from the level of the incisal edges of the lower anterior teeth and with or without an extra vertical over-jet of 1 to 2 mm.; thereby

setting up the anterior teeth according to a natural arrangement most appearing in nature; simultaneously

fixing the ridge-lap base of the anterior denture teeth, utilising pre-heated dental sticky wax, according to the course on or before of the alveolar ridge of the upper jaw, previously marked on the top of the upper denture base; thereby

setting-up the upper posterior denture teeth, for instance, in an occlusal ‘surface-to-surface’ centric bite contact, FIG. 2, C, (5) relative to the lower posterior denture teeth; thereby

having the upper posterior denture teeth setting-up limited anteriorly to the left and right tuberosity of the upper jaw, including any steep incline of the alveolar ridge, previously marked on the top of the upper bite-block base;

securing each upper posterior denture tooth with the ridge-lap of each tooth on or before the crest line of the alveolar ridge, marked previously on the surface of the bite-block base.

11. having either of the complete setting-ups denture teeth in centric occlusion further checked with the articulator (10) to adjust each setting up for a non-interfering exact centric-occlusion and consistent full balance articulation; thereof

in the case of a setting-up denture teeth with a curved inter-occlusal bite plane, releasing the bolt/nut (40),(39) and swivelling the curved upper articular block (35) on the curved lower articular block (34) of the curved articular joint (12) from its centric bite stand 3 to 5 mm. forwardly, as a protrusive articular bite contact and 3 to 5 mm left and right sidewardly (laterally), as a bi-lateral articular bite contact; thereby

in the case of a setting-up denture teeth with a planar inter-occlusal bite plane, releasing the bolt/nut (33) and swivelling the upper articular block (27) on the lower articular block (28) of the horizontal planar joint (11) from its centric bite stand 3 to 5 mm. forwardly as a protrusive articular balance bite contact and 3 to 5 mm. left and right sidewardly (laterally), as a bi-lateral articular bite-contact; thereby

any interference during the check for the balance articulation is adjusted by spot-grinding the interference, indicated by premature blue marks of blue articulating paper or liquid used between the inter-occlusal bite plane (3) and (4); thereof

12. anatomical contouring of the upper denture base, using dental modelling wax, around the junction tooth and base.

13. having the complete setting-up denture teeth in a prototype design-form resembling the pursued design-form of the preformed combination set complete arched denture teeth units (1)(2) upper and lower, as disclosed in FIG. 1, A, B, at least in a medium size;

Note: It will be understood that the set-ups of the method A, as described heretofore may be proceeded with the inter-occlusal bite-plane of the posterior denture teeth in a “surface-to-edge”, partly occlusal contact (6) as disclosed in FIG. 2, D of the drawing of present invention and as well as disclosed in the Australian Patent addition No 14741/95 of No642892 (main patent), instead of the exemplified setting up of ‘surface-to-surface’ full occlusal contact (5) as disclosed in FIG. 2 C, during the steps as heretofore described;

14. removing each jaw model-complex including their complete balanced set-ups of denture teeth from the articulator in order to duplicate the set-ups in an art plaster; hereto

utilising a self-curing, true moulding material as silicon or a derivative material thereof; thereby

forming an impression from each balanced setting-up combination set denture teeth and partly from the base; thereby

casting dental art plaster in the impression to set hard and to be used as the pursued prototype plaster model complex of the procedural ‘Phase 1’ method A, and substantially being an exact replica of the pursued preformed combination set complete arched denture teeth units (1) (2) as disclosed in FIG. 1, A,B, and accompanying description of the initial aspect of present invention.

In order to produce the pursued preformed combination set(s) A or B, in a preformed form of complete arched denture teeth units(s) (1),(2) as disclosed in the initial aspect of present invention, hereto the procedural ‘Phase 1’ of the method A is led in a procedural ‘Phase 2’ including further steps, and sub-steps thereof:

15. providing a durable mould structure in a manner that allows to avoid, the high expenditure of costs, equipment and time consuming for providing and using such mould structure to preform the combination set(s), A, B as detailed along the route of the conventional industrial mould processes; such mould processes may include, electro-forming, panthograph die forming, cad-cam or computerised engineering or combination thereof; instead an economised manner is provided; hereto

using a clear and durable synthetic plastics mouldable material suitable to form a mould from the prototype plaster model;

having the mould in such material characterising a capability to let harden by light a photo-curable catalyst a composite resin without any damage to the mould;

having the clear moulding material substantially based on a poly vinyl-chloride, designed for the vacuum forming process and preformed in a mouldable form substantially of a square sheet 120×120 mm., 5 mm. thick; thereof

vacuum forming the clear moulding material on the prototype plaster model for making an impression of it; thereby

using a regular dental technique as known for vacuum forming dental mouth guards, at least with the use of a heavy duty dual type vacuum apparatus or a combined pressure and vacuum type apparatus; thereof

trimming the moulded impression material in an external design-form of a dental mouth guard and in an internal design-form of an impression as a negative replica of said prototype plaster model complex; resembling the design form of the pursued combination set(s) (1) (2) A. B. FIG. 1.

removing the mould structure from the model, allowing the capability to preform either the pursued combination set(s) of complete arched denture teeth units upper and lower, or separate individual upper and lower denture teeth thereof, or separate units of posterior denture teeth upper and lower, or separate units of anterior denture teeth upper and lower.

Note: The applicant is aware that other clear moulding materials might be considered for making the mould. However according to his findings the present material is the most durable and suitable for proceeding, including chemically resistance to the pursued light curable synthetic resinous composite ceramic tooth material used to preform the pursued combination set(s) denture teeth units of present invention.

In order to use the present plastic mould structure to preform the complete combination set(s) of denture teeth units from a durable oral abrasion-proof material such as a ceramic tooth material, the procedural of ‘Phase 2’ of the present method A is led in a procedural ‘Phase 3’ method A including further steps and sub-steps thereof:

17. providing a suitable ceramic material composed of a high mineral content such as zircon, silica, or barium glass bound chemically with a bio-compatible polymer binder based eg. on a Bis-GMA dimethacrylates and suitable diluter, further including a photo curing chemical catalyst and the use of an intensive visible light source such as halogene to harden the material in the mould; hereto

18. proceeding eg. an available light curable ceramic composite material Z100, a brand and property from 3M, U.S.A. at least in a middle age human tooth colour most common in nature; thereby

coating or spraying firstly a release agent such as a thin silicon oil in the impression of the mould; thereafter

absorbing the coat with a tissue or a ear cotton stick or a fine dental brush applicator; further

applying the composite in a two layer structure substantially of an enamel shade (51) and dentine shade (52) as disclosed in FIG. (6), the anterior tooth, E, and the posterior tooth, F;

as further disclosed in FIG. 6. E, F, having the layer-structure in a sequence and layering style of an enamel (51) and dentine shade, (52), thereby having the dentine shade according to an available dentine shade B3 of Vita Lumina (Rauter, Germany) or shade B3 thereof from 3M (U.S.A.) in order to reproduce a common middle aged human tooth colour;

in the impression of the mould, layering the ceramic composite Z100 in an enamel shade superimposed with a Z100 in dentine shade at least in a middle age human tooth colour B3 as quoted heretofore;

having the combined enamel-dentine shade Z100, ceramic composite substantially in a form of an arched unitary hollow-crown-unit moulded into the mould impression of the arched upper or lower denture teeth unit (1), (2);

light curing the mould including the hollow-crown unit in a light curing apparatus, delivering a ventilated high intensive white light source, halogene 450 Nanometer wave length capacity, having, a maximum heat of 60-65° C. during the photo-curing polymerisation of at least 5 minutes to avoid any damage to the mould and improper moulding;

removing the mould including the hollow-crown units from the apparatus;

Note: It might be stated that some specific ceramic composite material is curable as well as by adopting the use of a dual light-self curable ceramic composite or a ceramic composite curable by laser light. However based on the principle of economics and proven reliability, the light curable ceramic composite method, related to the present mould structure and moulding technique to perform and preform the combination set(s) A, B of denture teeth units (1) (2), is more suitable and proven by tests.

19. In order to provide a sufficient impact and bonding strength for the moulded hollow-crown unit of Z100, avoiding herewith breakage during further steps of proceeding and application of any of the completed denture teeth units (1), (2) to custom denture work; hereto the ‘Phase 3’ method A includes further sub-steps:

filling any of the hollow-crown units with a core (53) of a self curable synthetic resin eg. a rigid hard type curable ethyl-methacrylate predetermined for characterizing an impact resistance and high bonding strength for the units when applied to custom denture work; further

having the core (53) in a form substantially of a rigid unitary substructural crown-frame unit, at least in a dark greyish-yellow-brown shade to enhance the pursued middle age tooth colour, such as B3 as quoted before; thereby

having the substructural tooth-frame unit (53), as disclosed in FIGS. 6, E, F, composed of an arched arrangement including individual anterior and posterior denture teeth in a reduced form according to the combination set (1), (2), A,B, thereby each tooth is interconnected with an individual connector (54); thereby

having the base (26) of the anterior denture teeth E, and posterior denture teeth, F, and connectors (54) of the united hollow crown and substructural tooth-frame unit as disclosed in FIG. 6, formed substantially as a unitary ridge lap of the units (1), (2), A or B, FIG. 1.

Note:

1) It is obvious that other reinforcing synthetic resins may be used for the core such as a poly-carbonate preformed in substructural tooth-frame units; however based on the economic principle for the invention, the heretofore specified united hollow crown and tooth-frame units and resinuos-design technique is considered as being more economic and practical for the invention, and is part of the invention.

2) Referring to FIGS. 7 G, H, it might be contemplated for the application of the preformed units (1), (2), A or B FIG. 1 executed regularly to custom denture work which includes a thin methacrylate denture base, G in this instance an extra metallic reinforcement (17), (18) substantially of 2 to 3 twisted wires of the titanium or super alloyed steel, about 1.2 mm. or substantially of a grid bar 1.5 mm. thick is applicable to the labial region and in the palatal region of the denture base; while an immediate denture base H includes said metallic reinforcement (17),(18), respectively in the alveolar ridge region and palatal region of the immediate denture base.

20 In order to avoid distortion and to enable to handle the units (1),(2) during their further preformation in the mould structure and light curing, to polymerise the units which are in proceeding; including the sub-steps hereto

providing a gripping instrument configured as a spider, substantially devised with at least 3 to 5 metallic legs either formed from wires or rods, ±3 mm. Ø; thereby

having one end of each wire threaded and bent to be connected into an inverted formed spigot of plastic used as a base; thereby

having the other end of each wire threaded and bent in an angle of 45° to be connected with the self-cure ethyl methacrylate resin on the unitary ridge lap base (26) of the crown-frame unit; further

using the spigot base devised for holding, placing, or removing any of these denture teeth units during their proceeding; further

removing the moulded arched unitary hollow-crown unit united with the unitary substructural tooth-frame unit from the mould; thereby

coating an air barrier available from Denstply U.S.A. or Kulzer, Germany, on the outer-aspect of these crown-units;

using the spigot base to place and stand any respective one of the completely moulded cross-units during a further light curing of 5 minutes in the light curing apparatus; thereafter

removing the cured crown-units from the apparatus thereby removing the air barrier coat using water/detergent and a tooth brush, thereafter trimming and polishing of the denture teeth units using a nylon wheel-brush, diamond paste and dental hand piece/power tool; thereafter

disconnecting the gripping instrument from the finalised crown-units substantially as the denture teeth units (1), (2), using a cutting wheel to separate the ethyl methacrylate connection, from the unitary ridge-lap base (26);

Note: It will be understood that the prior art has initiated the provision of a light curable ceramic composite such as Z100 or other brands to create clinically aesthetic fillings or veneers with the purpose to restore aesthetically and directly natural teeth in the mouth or indirectly in the laboratory.

As well as other prior art attempts have been initiated to pre-manufacture separate denture teeth from other specific light curable composite resins without additional ceramic, or baked ceramic at high temperatures.

However such resin composite denture teeth pre-manufacture was achieved along a conventional route of making denture teeth by high expensive non-corrosive metallic moulds and cumbersome use of it, by using high expensive equipment and skilled labour.

In these instances it was not previously recognised that attributes of the kind of method A of present invention were providing a durable economic mould structure for the laboratory as well as for the industry.

On one hand this provision made it particularly useful for other dental techniques such as preforming a combination set(s) of complete arched denture teeth units FIG. 1, (1), (2), A, B, for setting up complete sets in an instant and adjustable non-interfering full balance articulation. On the other hand useful for preforming partly arched denture teeth units or preforming separate denture teeth to be suitable for a non-interfering full balanced articulation of partial bi-lateral free-end custom denture work or complete implant over-denture work achieved in the laboratory.

And yet in another aspect of present invention, there is provided a Method B for the use of setting-up in an instant and adjustable full balanced articulation, the preformed combination set(s), A, B at least in a medium size, including complete arched denture teeth units (1)(2), A, or B obtained from the Method A. Thereby having the setting up either according to a planar or curved inter-occlusal bite plane applicable to complete regular or over-denture or complete implant or denture or partial bi-lateral free-end custom denture work achieved in the laboratory.

Note:

1) It will be understood that the method B in general follows merely the technique including the steps 1-5, of the setting-up one by one of the complete combination set(s) separate denture teeth by use of the provision suitable dental aids as disclosed in the method A, procedural ‘Phase 1’.

2) In comparison with Method A, procedural ‘Phase 1’, the only difference of Method B is related to the technique of the steps 6-17, which follows the previous steps, 1-5 of Method A and which are steps provided for and disclosed in the procedural ‘Phase 1’ of Method A.

3) Thereby the difference of the steps 6-17 of Method B is related to a technique for setting-up in an instant and adjustable full balanced articulation, a combination set(s) A or B, FIG. 1 at least in a medium size of complete arched denture teeth units upper and lower (1), (2) A or B. FIG. 1 and in a design-form as disclosed in the initial aspect of present invention.

With the Method B in mind, an exemplification of setting-up the combination set(s), at least in a medium size, of complete arched denture teeth units (1)(2), FIG. 1 A, or B, either according to a planar or curved inter-occlusal bite plane in an instant and adjustable full balanced articulation, will now be disclosed with steps according to the sequence related only to the Method B.

Hereto, as the total steps of Method B, are outlined with the use of the similar provision of the suitable dental aids of Method A (except for the provision of 2 complete combination set(s) separate denture teeth upper and lower), in this instance, the provision of the suitable dental aids will be outlined shortly as the initial step 1 of Method B:

1. Preparing a provision of suitable dental aids for setting up a combination sets(s) complete arched denture teeth units upper and lower (1) (2), A or B, FIG. 1, on a universal balance dental articulators, having the provision including:

a upper and lower plaster jaw model complex predetermined with a height of 40 mm. and substantially as a replica of a natural total endentulous upper and lower human jaw complex at least in a medium size;

a complementary upper and lower orally recorded bite block complex in centric occlusion predetermined with a height preferably of 40 mm;

an adjustable wall shelf or a tower dental bench with adjustable shelves;

a customised universal balance dental articulator predetermined with an internal height of at least 110 mm; thereby devised with a horizontal and curved sphero-ellipsoidal (conforming at least a 4 inch (11 cm) radius of a sphere) releasable-fixing articular joint structure; thereby having each articular joint structure parallel with each other, and laterally and horizontally extended with a corresponding mutual releasable-fixing upper and lower tray member, parallel to each other;

a set of auxiliary instruments complementary to the articulator and comprised of a releasable fixing planar mounting plate; further an occlusal balance device including a releasable-fixing base fitted and replaceable with vertically adjustable non-rotary telescopic arbors fitted with a releasable-fixing planar or curved sphero-ellipsoidal (conforming a 4 inch (11 cm) radius of a sphere) occlusal guide plate;

two preformed combination sets (A, or B) of complete arched upper and lower denture teeth units, each set including the design form and characteristics as detailed in the initial aspect of the invention; thereof

2. from the provision, using the wall shelf or the tower dental bench with releasable shelves adjustable to the individual eye level, enabling to proceed accurately the steps which follow;

3. from the provision: using the complementary orally recorded bite block complex mountable on the plaster jaw model complex, and used as an assembly to be fixed on the articulator; simultaneously:

having the jaw model complex fixed and releasable in centric occlusion on the upper and lower tray member of the articulator of the provision; hereto

using the planar mounting plate which is fixed and attachable at mid of the internal height of 110 mm. of the articulator; thereby

using the regular dental bite-block mounting procedure related to the horizontal occlusion and articulation for a complete denture setting up;

4. releasing the fixed upper jaw model including the complementary upper bite recording block from the upper tray member of the articulator;

5. from the provision, using the telescopic occlusal guide with its base suspended and fixed, while releasable with a cross pin, on the vacant upper tray member of the articulator;

6. from the provision, defining to use either the releasable-fixing planar or curved occlusal guide plate, respectively dependable from the nature of the temporo-mandibular joint of the human's jaw complex which is individual, either according to a planar or curved shape, and recognised by x-ray;

7. having the arbor suspended vertically and releasable fixing with its upper end onto the base of the occlusal guide

suspending horizontally and releasable fixing, either of the occlusal guide plates defined to be as suitable, thereby at a planar level and at lower end of the vertically adjustable non-rotary arbor of 40 mm length; thereby

having the inter-occlusal bite-plane form defined suitable either planar or curved in harmony with the form of the human's temporo-mandibular joint and its associated condyle path movements being either planar or curved recognised by x-ray; hereto

8. positioning the defined occlusal guide plate, by sliding vertically the telescopic arbor of 40 mm. length, downwardly at a suitable overhead distance from the lower bite recording block remained mountable on the lower plaster jaw model remained fixed but releasable in the initial centric occlusal stand on the lower tray member of the articulator; thereby

9. having the overhead-distance defined to be as suitable for use, at a level which allows a free way space to be sufficient for setting-up initially and freely the lower arched denture teeth unit of the provision; thereof

having the lower denture teeth unit placed between the base of the lower bite block, without occlusal wax bite rim, and the under-surface of the suspended occlusal guide plate defined as suitable for the case in use:

10. setting up the arched lower denture teeth unit in the free way space, at the distance level defined as sufficient, in order to establish either of the inter-occlusal bite plane forms for the lower and the upper arched denture teeth unit respectively in use during the setting-up; thereby

positioning the unitary ridge-lap base of the lower denture teeth unit, at least at a distance of 0.5 mm. from or before the course of the crest of the base of the lower bite block, mounted in the centric occlusal stand on the lower jaw model fixed on the lower tray member of the articulator; simultaneously

positioning the distal proximal surface of the left and right end of the lower denture teeth unit respectively anterior to the region of the right and left end of the lower bite recording block respectively covering the left and right retromolar pad region, including any incline of the alveolar ridge anterior to the pads, of the lower jaw model and marked previously on top of the lower bite-block base; simultaneously

having the inter-occlusal bite plane of the lower denture teeth unit, in exact contact to the under-surface of the suspended and positioned occlusal guide plate, used in a form defined as suitable either planar or curved which may be the case; thereof

11. fixing the setting-up of the arched lower denture teeth unit, using a hard shrink free dental sticky wax plasticised by heat between the ridge-lap base of the lower denture teeth unit and on or before the course of the crest of the base of the lower bite recording block;

12. contouring the base of the lower bite block, initially made as a final plastic denture base, thereby substantially in a shape sufficient stable in the mouth, hereto using hard dental modelling wax;

13. removing the occlusal guide from the upper tray member and releasable-fixing the previously removed upper jaw model, initially mounted with the upper bite block in the centric occlusal stand and without the wax bite occlusal rim, on the vacant upper tray member;

14. from the provision, using and setting-up the complete arched upper denture teeth unit, with the occlusal bite-plane in centric occlusal stand, either with a full or partly occlusal contact on the occlusal bite plane of the lower denture teeth unit; hereto

having the occlusal upper bite plane either in a planar or curved form conformed to the occlusal bite plane form of the lower denture teeth unit defined and used either planar or curved during the setting-up of the lower denture teeth unit; thereby

having the unitary ridge-lap base of the upper denture teeth unit adapted at least at a distance of 0.5 mm. from or before the course of the crest of the base of the upper recording bite block mounted on the upper jaw model fixed on the upper tray member of the articulator; thereby

having the distal proximal surface of the left and right end of the upper denture teeth unit respectively anterior to the region of the right and left end of the upper bite recording block base covering the corresponding left and right tuberosity region, including any incline of the alveolar ridge anterior to the tuberosities respectively marked on the bite block base, of the upper jaw model; simultaneously

setting the anterior denture teeth either edge-to-edge or with a extra horizontal over-jet of two to three mm. relatively to the incisal edges of the lower anterior denture teeth; further

15. fixing the setting-up of the arched upper denture teeth unit hereto using hard shrink-free dental sticky wax plasticised by heat between the ridge-lap base of the upper denture teeth unit and on or before the course of the crest of the base of the upper recording, block;

16. adjusting the inter-occlusal bite-plane of the upper and lower denture teeth unit for a total even centric occlusal contact and non-interfering eccentric bi-lateral and protrusive balanced articular contact; hereto

using rotary gliding movements with the universal balance articulator used from the provision dental aids; thereby

in the case of a curved inter-occlusal bite plane, established with the curved sphero-ellipsoidal occlusal guide plate, releasing the bolt-nut of the fixed curved articular joint devised on the lower articulator member; thereby

applying the jaw movements, by sliding the upper curved articular block on the lower curved articular block either forward-backward or bi-lateral left and right;

in the case of a planar inter-occlusal bite plane, established with a planar occlusal guide plate releasing the bolt-nut of the fixed planar articular joint, located at the mid height of the articulator base; thereby

applying the jaw movements using similar sliding technique as defined for the curved articular joint, by using the upper planar articular block on the lower planar articular block,

adjusting either of the inter-occlusal bite planes by removing any interfering centric and eccentric articular contacts which are removed by established dental spot-grinding articular procedures either with blue articulating paper or coloured powder or liquids;

17. using hard dental modelling wax, contouring the upper bite block base, made initially as a basic upper denture base of plastic, made orally stable with an orally non-interfering and retentive basal seat.

Note:

1) Referring to Method B, it will be understood that in a case of setting-up a combination set complete arched denture teeth units, for a complete custom denture, which requires a planar inter-occlusal bite plane, in this instance, two possibilities are provided. Hereto firstly the setting up maybe performed with the universal balance dental articulator included either with the curved articulator joint but in a fixed static condition or, without the curved articular joint by having the lower jaw model fixed with plaster directly on the lower tray member as executed with a conventional horizontal balance dental articulator procedure.

2) Referring to FIG. 3 of the drawing and to the brief description of this Figure at page 5, there is disclosed a setting up of a complete custom denture including a combination set A or B of a complete arched upper and lower denture teeth unit, designed with a planar inter-occlusal bite plane in a balanced horizontal articulation, which is achieved on a conventional horizontal balance dental articulator including only a horizontal articular joint; thereby

having the denture further applied to a human jaw complex characterised with a curved temporo-mandibular joint in conjunction with a full endentulous upper and lower jaw including a severe resorption or being submitted to a resorption as in most cases; thereby having the joint functional with a curved condyle path movement; thereof as shown

there is a posterior separation of the planar inter-occlusal bite plane, indicated by the mark (<), caused during a foreward or bi-lateral movement of the jaw; consequently

there is a loss of a full balanced articular contact causing the lower denture to skid forward with loss of the fit of the denture and severe damage to the jaw and temporo-mandibular joint.

3) To resolve the problem, a curved sphero-ellipsoidal inter-occlusal bite plane is applied, conformed to a 4 inch radius of a sphere.

having the curve of the inter occlusal bite-plane serving as a anterior-posterior and bi-lateral compensating curve, during the setting up of the combination set denture teeth, of the denture on the universal balance dental articulator provided with the curved articular joint, and occlusal guide provided with the curved occlusal guide plate and performed in accordance with the Method B; besides;

during the application of the denture to the human jaw complex, FIG. 3 exploiting the flexibility of the temporo-mandibular joint of the endentulous jaw complex and which is adaptable to the individual curve of the human joint structure;

4) During tests made it is detected that the structure of the articulator joint and of the incisal guidance, related to and used on a conventional semi- or full-adjustable anatomical condyle balance dental articulator, is not in an exact functional co-ordination with the bi-lateral and anterior-posterior curve of the inter-occlusal bite plane of a setting-up achieved with the combination of the set(s) denture teeth units of present invention in accordance with the Method B proceeded on such conventional articulator; in this instance

by further tests during the performance of the step for checking and adjusting the setting up, for a non-interfering full consistent balanced articulation of the setting-up on such articulator; consequently

an over-excessive grinding was required to adjust the required specific articulation, as aimed in the invention, and which was leading to the full elimination of the detailed crushing occlusal surface of the inter-occlusal bite plane conformed according to the required 4 inch radius of a sphere.

5) In view of the foregoing remark 4 of the ‘Note’, in a case of a setting up of a combination set upper and lower denture teeth either separated or interconnected in complete upper and lower arched units, A or B for a complete custom denture which requires a curved inter-occlusal bite plane; it might be stated:

the coordination of the sphero-ellipsoidal design-form, conformed at least to a radius of a 4 inch (11 cm) of a sphere and which is applied to the curved occlusal guide plate of the occlusal guide and to the curved articular joint of the universal balanced dental articulator; thereof

having the occlusal guide plate and the curved articular joint aligned at a horizontal level and similar position but spaced apart form each other; in these instances

the coordinated design-form enables the universal balance dental articulator of present invention to produce the correct sphero-ellipsoidal gliding and rotary movements for the step of checking and adjusting the setting up in a full non-interfering balanced articulation; thereby

having the movements enabling the capability to imitate the gliding and rotating of the human's temporo-mandibular joint, based on the flexibility of the temporal-mandibular joint, and is part of the present invention.

6) In view of foregoing remark 5), it will be indicated that the Method B and the preformed combination set(s) denture teeth of Method A of present invention, provides a efficient manner of setting up the combination set(s) denture teeth (1) (2) A, B, in an instant and adjustable full non-interfering balanced articulation during custom denture work.

In this instance the custom denture work may be performed to a permanent or immediate denture, or over-denture, or implant denture or implant over-denture or partial bi-lateral free-end denture upper or lower.

Conclusion: Based on the facts of 1-6 as disclosed in the foregoing ‘Note’ thereby in view of the general objective of present invention, indeed there is a need for the provision of a simplified universal balance dental articulator and complementary balance instrumentarium and the provision of the preformed combination set(s), A or B, denture teeth either separate or interconnected in arched units, complete or partly, thereby performed in accordance with the Method A and Method B for a setting-up of custom denture work in a non-interfering full consistent balanced articulation suitable in the mouth, with a minimum expenditure of equipment and labour and time consumed.

While the invention has been illustrated and described in detail in the drawing and foregoing description, the same is to be considered as illustrative and not restrictive in character. Thereby it being understood that only the preferred embodiment has been shown and described, and that all changes and modifications that come within the meaning and equivalancy range of the appended claims, are also desired to be protected.

In that respect the embodiment of present invention may be of course carried out in other specific ways than those set forth and equivalent maybe substituted for elements thereof. Also it is intended that broad claims, such as indepent claims not specifying datas of a particular embodiment disclosed herein as the best manner contemplated for carrying out the invention should not be limited to such datas.

It will be understood that adding or deleting, or combining or using alternative steps or acts modifying steps or acts or the sequence of the steps or acts involved in the methods of present invention for carrying out this invention in other specific ways than these set forth and equivalents may be substituded for elements thereof, without to improve a serious defect or limitations or use of the invention: in these instances such act may be contemplated as an infringement action to the spirit and consequently to the idea of the present invention.

And yet it will be understood that adding or deleting or combining or modifying or using alternative features which are involved in the product(s) or article(s) or element(s) of present invention and whereby these features are not essential to improve the product(s) or articles(s) or element(s) or their limitation to carry out the invention as said heretofore or for using the invention for a total different application and spirit, by a person intending to use this invention without any sense, in these instances such act may be contemplated as an infringement action to the spirit and consequently to the idea of the present invention.

The claims defining the invention are as follows:

1: Combination set (A, B) of complete arched denture teeth units without denture base structure for setting-up custom dentures, comprises: a complete upper denture teeth unit (1) substantially of anterior and posterior denture teeth inter-connected in an arch form thereby combined separately with a complementary complete lower denture teeth unit (2) substantially of anterior and posterior denture teeth interconnected in an arch form; each of the units includes a total unitary inter-occlusal bite plane preformed in a mutual centric occlusion; having the set characterized in that the inter-occlusal bite plane is predetermined in a design-form whereby the inter-occlusal bite plane of the posterior denture teeth of the units is cuspless sphero-ellipsoidal pre-set according to an anterior-posteriorly curved and separately according to a planar level, thereby included with a free centric inter-occlusal contact, either full (5) or partly (6) and a free eccentric articular balance contact thereof, further the set (A, B) is non-bendable, form-stable and substantially of a durable abrasion-proof, colour-fast rigid aesthetic tooth material; thereof having the set (A,B) substantially with the capability for setting-up accurately the denture teeth of the custom dentures, in an instant and adjustable full balanced bi-laterally and protrusive articulation.

2: A combination set as claimed in claim 1, in which the arch form size of he complete upper (1) and complementary complete lower (2) denture teeth unit of the set is either in a fully complete extended or in a under-extended complete arch form whereby the last left and right posterior denture tooth, in terms and function as second molars, are excluded from each unit.

3: A combination set as claimed in claim 1, in which the posterior denture teeth of the set, (A, B), in terms and function as premolars and molars, are predesignated in a design form including either a regular or irregular buccal-lingual and buccal-palatal width related at least to one left and one right molar of the complete upper and the complete lower denture teeth unit of the set; whereby the irregular buccal-lingual and buccal-palatal widths are designed without tongue interference and broader than the buccal-lingual and buccal-palatal width related either to the pre-molars of the combination set denture teeth units, or to the premolars and molars of a regular set of separate individual denture teeth; having the irregular buccal-lingual and buccal-palatal width substantially for creating a consistent stabilized bi-lateral individual balance articular contact for the total unitary inter-occlusal bite plane of the units (1)(2) particularly suitable in a condition of a human's temporo-mandibular joint being larger or flailing than usually.

4: A combination set as claimed in claim 3, in which the molars of the posterior denture teeth of the set, characterized by the irregular buccal-lingual and buccal-palatal width, are formed with the buccal part out of alignment buccalwardly with the contour of the buccal part of the premolars of the posterior denture teeth of the set, while the lingual part and palatial aspect of the molar teeth are in a regular alignment with the contour of the lingual and palatal part of the premolars of the posterior denture teeth of the set.

5: A combination set as claimed in claim 1 or 2, in which the set is either substantially at least in a medium arch size, or in different arch form sizes including large, medium and small; thereby each arch form size is at least in a oval configuration, in one colour most common in nature related to a middle human age, further preformed with anterior and posterior denture teeth including an outer aspect at least in a naturally tapered form preferably trapezoid, and in a tooth arrangement most common in nature.

6: A combination set as claimed in claim 5, in which the set of different arch form sizes, when combined with each other are suitable to accommodate individual setting-ups of denture teeth in bi-lateral and protrusive full balanced articulation applicable to three different types of upper and lower jaw relations regularly appearing in human jaw complex.

7: A combination set as claimed in claim 1, in which the aesthetic tooth material or the set (A,B), is substantially of ceramic or of a light curable or dual light-self curable ceramic composite; having either of the materials, during preforming the set substantially designed and formed with a mechanical retentive shape for a durable hold of the set when applied to denture base materials of the custom dentures.

8: A combination set as claimed in claim 7, in which the set (A,B), is substantially of the ceramic composite including a core formed with a unitary ridge lap base of an impact resistant rigid hard ethyl or impact resistant methyl methacrylate rendering a durable chemically bonding retentive shape and impact resistance when the set is in combination with denture plastic base materials of customised dentures.

9: Method of forming a durable mould structure for preforming from an aesthetic tooth material a combination set(s) denture teeth, having the set(s) composed of a complete upper and complementary complete lower denture teeth unit; having each unit at least in a medium size or in different sizes including anterior and posterior denture teeth interconnected in a fully complete or under-extended complete arch form; having each unit formed with a unitary inter-occlusal bite plane characterized by a full pre-set balanced articular design-form pre-determined for setting up these set(s) denture teeth accurately in an instant and adjustable full individual balanced articulation; further having the unitary inter-occlusal bite plane of the posterior denture teeth cuspless and sphero-ellipsoidal and pre-set according to a curved and separately a planar level including a free-centric inter-occlusal contact either full (5) or partly (6) and a free-eccentric articular balanced contact; thereof having the method characterized by having the mould structurally obtained along a route of avoiding a high expenditure of equipment for making and using the mould to preform the combination set(s) denture teeth units in the durable tooth material.

10: A method as set forth in claim 9, wherein the method includes steps for preparing a provision of dental aids including: a plaster upper and lower jaw model complex predesignated with a suitable height of 40 mm., substantially as a replica of a natural totally endentulous upper and lower human jaw complex at least in a medium size; a complementary upper and lower bite-block complex recorded orally in centric occlusion and predesignated with a height of 40 mm. mountable on the jaw model complex and used as an assembly fixed and releasable on a dental articulator; further a dental articulator substantially devised as a customized universal balance dental articulator predesignated with a suitable internal height of at least 110 mm. or more and with a releasable-fixing universal articular joint structure composed of a combination substantially of a releasable-fixing horizontal planar articular joint and of a releasable-fixing curved sphero-ellipsoidal (conformed to a 4 inch (11 cm) radius of a sphere) a releasable-fixing articular joint; further a set of auxiliary instruments complementary to the articulator, whereby the set comprises a planar releasable-attachable mounting plate, a releasable-fixing vertically suspended and adjustable telescopic occlusal guide; two releasable-fixing occlusal guide plates, one in a planar shape, the other in a curved shape (conformed at least to a 4 inch (11 cm) radius of a sphere); further the provision includes two complete sets of upper and lower separate individual denture teeth at least in a medium size, including posterior denture teeth predesignated with a cuspless curved sphero-ellipsoidal (conformed to a radius of 4 inch (11 cm) of a sphere) occlusal bite surface at least with a sufficient buccal-lingual width for the lower posterior molar denture teeth and with a sufficient similar buccal-palatal width for the upper posterior molar denture teeth complementary to the lower posterior molar denture teeth; further a adjustable wall shelf or a tower dental working bench devised for setting up the set(s) of denture teeth at a suitable level of the individual eye-sight.

11: A method as set forth in claim 10, wherein the method includes further the steps: • using the provision of dental aids for setting-up on the balance dental articulator two complete sets of separate individual upper and lower denture teeth having each setting-up according to a different unitary inter-occlusal bite plane level; • having one setting-up with the inter-occlusal bite plane according to a planar level and one setting up according to an anterior-posteriorly curved level, (conformed to a 4 inch (11 cm) radius sphere); having each bite plane at least in an exact free centric occlusion, oval arch form and curved sphero-ellipsoidal cross-section, (conformed to a 4 inch (11 cm) radius of a sphere); • having each different levelled inter-occlusal bite plane either with a full (FIG. 2, C5) or partly (FIG. 2, D, 6) occlusal contact. • having any of the levelled inter-occlusal bite planes, if required further adjusted in a full (bi-lateral and protrusive) non-interfering balanced articulation.

12: A method as set forth in claim 9 or claim 11, wherein the method includes further the steps: • forming a proto-type plaster model complex substantially in a form as an exact replica of each of the complete setting-ups separate individual denture teeth thereby one setting-up according to the planar and the other setting-up according to the curved level; • hereto taking a form-true rubber impression of each of the setting-ups separate denture teeth; •casting dental art plaster to set hard in each respective impression; • removing the casting substantially as the proto-type plaster model complex used as a design-form and replica for matching the pursued combination set(s) of the complete arched denture teeth units upper and lower (1), (2) at least in a medium size one set formed according to a planar and the other set according to anterior-posteriorly curved level.

13: A method as set forth in claim 12, wherein the method includes further the steps: • forming a durable mould structure including an exact negative impression of the proto-type plaster model complex; hereto • taking a form true impression substantially of a synthetic elastic plastics material, which is shrink free, relatively heat resistant, transparent, form stable, chemically resistant and non-adhesive at least to white light curable resinous materials; hereto • using at least a clear poly-vinyl chloride plastics in a blank/form including 4 millimetres thick, 10 cm×10 cm square or round for making the impression; • moulding the blank on top of the proto-type plaster model complex to set hard on it by using either an established vacuum or vacuum-pressurising dental moulding procedure; • removing and finishing the moulded impression as a durable form-true mould structure; • preferably having the mould structure in a external design form of a dental mouth guard appliance and in a internal design form of an impression as a negative replica of the proto-type plaster model complex.

14: A method as set forth in claim 13, wherein the method includes further the steps: • in the impression of the mould structure complex forming the pursued preformed combination set(s) of complete arched denture teeth units upper and lower either with a planar or curved sphero-ellipsoidal inter-occlusal bite plane; hereto • coating or spraying and absorbing a thin silicon oil in the impression of the mould-structure. • moulding any of the units in a durable aesthetic tooth material substantially of a light curable or light-self curable tooth coloured ceramic composite united in combination with a self-curable tooth coloured impact resistant rigid-hard ethyl or methyl methacrylate resin; • in the impression of the mould firstly layering the ceramic composite in an enamel shade, super imposed with a dentine shade at least in a middle age human tooth colour; • having the combined enamel-dentine shade substantially in a form of an arched hollow tooth crown-unit moulded into the mould impression of either of the denture teeth units; • light curing the mould including either of the hollow tooth crown-units in a light-curing apparatus of a 450 nanometer capacity, for a least 5 minutes at a maximum heat of 60 to 65° C. degrees; • removing the mould including either of the hollow tooth crown-units from the apparatus and filling either of the hollow tooth crown-units with a core of self curable resinuous impact resistant ethyl-methacrylate substantially in a form of a rigid arched unitary substructural interconnected tooth-frame unit characterising an impact resistance and bonding strength applicable to either of the arched upper or lower denture teeth unit of the combination set(s); • having the ethyl-methacrylate at least in a dark greyish-brown-yellow shade to enhance the middle age human tooth colour of the hollow-crown-unit; • interconnecting the ridge-lap base of either of the united hollow tooth crown-substructural tooth-frame unit using self curing ethyl-methacrylate including a gripping instrument for removing and proceeding further the units with the mould; • coating the exterior of either of the united hollow tooth crown substructural tooth-frame units with an air barrier jelly, placing either of the heretofore coated units using the base of the interconnected gripping instrument for 5 minutes light curing in the light curing apparatus; • removing either of the united hollow tooth crown-tooth frame units from the apparatus for removing the jelly coat with a diluted detergent and tooth brush, further finishing either of the units including high lustre polishing, and disconnecting the wire instrument from the unit.

15: A method as claimed in claim 9 or 14, in which the durable mould is substantially of a design form and structure thereof including an impression for preforming, from the durable aesthetic tooth material, the denture teeth of the combination set(s) either separately one by one, or in units of 6 upper and 6 complementary lower anterior denture teeth respectively, or in units of 4 left and 4 right upper and 4 left and 4 right complementary lower posterior denture teeth preformed either with the gripping instruments or not.

16: A method as claimed in claim 14, in which the gripping instrument is an auxiliary tool complementary to the durable mould and devised in a design form structurally like a spider able to grip without distortion either the upper or lower complete arched denture teeth unit from the mould as well as for holding and placing either of the units during-preforming of the denture teeth units; thereby composed of 3-5 either metallic wires or rods, ±4 mm. Ø thick ±60 mm. length and bent in an angle about 45°-90°, having one end of each of the wires threaded or bent used to interconnect with self cured rigid-hard ethyl-methacrylate a relatively heat resistant inverted spigot-like shaped base to be used as a finger grip or as a stand for placement; thereby having the other end of each wire threaded and interconnected with the self-cure ethyl methacrylate on the ridge lap base either of the upper or lower arched hollow tooth crown-tooth frame unit.

17: A method as claimed in claim 14 or 15, in which the durable aesthetic tooth material is either solely based on the ceramic composite formed substantially in the preformed combination set(s) denture teeth, thereby formed with a mechanical retention in the ridge lap base of the combination set(s) denture teeth, while the aesthetic tooth material based on the composite ceramic united with the ethyl-methacrylate plastics is formed with a chemical and bondable retention on the ridge lap base made of ethyl-methacrylate as part of the united ethyl-methacrylate plastics in the form of a core united in the set(s), having either of the retention forms applicable to plastic denture base material during custom denture work.

18: Method for setting-up a combination set(s) complete arched denture-teeth units upper and lower preformed in a complete or under extended complete arch form including a sphero-ellipsoidal inter-occlusal bite plane being either planar or curved and made of a synthetic durable aesthetic tooth material at least in a middle age tooth colour most appearing in nature, having the method characterized in: that the method is carried out along a route of setting up the set(s) arched denture teeth units in an instant, accurate and adjustable full consistent balanced articulation during custom denture work and its application.

19: A method as claimed in claim 18, in which the method includes the further steps:
1. Preparing a provision of suitable dental aids for setting up a combination sets(s) complete arched denture teeth units upper and lower (1) (2), A or B, FIG. 1, on a universal balance dental articulator thereby having the provision including:
a upper and lower plaster jaw model complex predetermined with a height of 40 mm. and substantially as a replica of a natural total endentulous upper and lower human jaw complex at least in a medium size;
a complementary upper and lower orally recorded bite block complex in centric occlusion predetermined with a height preferably of 40 mm.
an adjustable wall shelf or a tower dental bench with adjustable shelves:
a customised universal balance dental articulator predetermined with an internal height of at least 110 mm; thereby devised with a horizontal and curved sphero-ellipsoidal (conforming at least a 4 inch (11 cm) radius of a sphere) releasable-fixing articular joint structure; thereby having each articular joint structure parallel with each other, and laterally and horizontally extended with a releasable-fixing tray member; substantially as a hollow tapered upper and lower tray member parallel to each other;
a set of auxiliary instruments complementary to the articulator and comprised of a releasable-fixing planar mounting plate; further a vertically adjustable telescopic occlusal guide including a releasable-fixing base fitted and replaceable with vertically adjustable non-rotary telescopic arbors fitted with a releasable-fixing planar or curved sphero-ellipsoidal (conforming a 4 inch (11 cm) radius of a sphere) occlusal guide plate;
two preformed combination sets (A, or B) of complete arched upper and lower denture teeth units, the design form; thereof
2. from the provision, using the wall shelf or the tower dental bench with releasable shelves adjustable to the individual eye level, enabling to proceed accurately the steps which follow;
3. from the provision: using the complementary orally recorded bite block complex mountable on the plaster jaw model complex, and used as an assembly to be fixed on the articulator; simultaneously;
having the jaw model complex fixed and releasable in centric occlusion on the upper and lower tray member of the articulator of the provision; hereto
using the planar mounting plate which is fixed and attachable at mid of the internal height of 110 mm. of the articulator; thereby
using the regular dental bite-block mounting procedure related to the horizontal occlusion and articulation for a complete denture settings up;
4. releasing the fixed upper jaw model including the complementary upper bite recording block from the upper tray member of the articulator;
5. from the provision, using the telescopic occlusal guide with its base suspended and fixed, while releasable with a cross pin, on the vacant upper tray member of the articulator;
6. from the provision, defining to use either the releasable-fixing planar or curved occlusal guide plate, respectively dependable from the nature of the temporo-mandibular joint of the human's jaw complex which is individual, either according to a planar or curved shape, and recognised by x-ray;
7. having either of the arbors suspended vertically and releasable fixing with its upper end onto the base of the telescopic occlusal guide;
suspending horizontally and releasable fixing, either of the occlusal guide plates defined to be as suitable, thereby at a planar level and at lower end of the vertically adjustable non-rotary arbor of 40 mm length; thereby
having the inter-occlusal bite-plane form defined suitable either planar or curved in harmony with the form of the human's temporo-mandibular joint and its associated condyle path movements being either planar or curved recognised by x-ray; hereto
8. positioning the defined occlusal guide plate, by sliding vertically the telescopic arbor of 40 mm. length, downwardly at a suitable overhead distance from the lower bite recording block remained mountable on the lower plaster jaw model remained fixed but releasable in the initial centric occlusal stand on the lower tray member of the articulator; thereby
9. having the overhead-distance defined to be as suitable for use, at a level which allows a free way space to be sufficient for setting-up initially and freely the lower arched denture teeth unit of the provision; thereof
having the lower denture teeth unit placed between the base of the lower bite block, without occlusal wax bite rim, and the under-surface of the suspended occlusal guide plate defined as suitable for the case in use;
10. setting up the arched lower denture teeth unit in the free way space, at the distance level defined as sufficient, in order to establish either of the inter-occlusal bite plane forms for the lower and the upper arched denture teeth unit respectively in use during the setting-up; thereby
positioning the unitary ridge-lap base of the lower denture teeth unit, at least at a distance of 0.5 mm. from or before the course of the crest of the base of the lower bite block, mounted in the centric occlusal stand on the lower jaw model fixed on the lower tray member of the articulator; simultaneously
positioning the distal proximal surface of the left and right end of the lower denture teeth unit respectively anterior to the region of the right and left end of the lower bite recording block respectively covering the left and right retromolar pad region, including any incline of the alveolar ridge anterior to the pads, of the lower jaw model and marked previously on top of the lower bite-block base; simultaneously
having the inter-occlusal bite plane of the lower denture teeth unit, in exact contact to the under-surface of the suspended and positioned occlusal guide plate, used in a form defined as suitable either planar or curved which may be the case; thereof
11. fixing the setting-up of the arched lower denture teeth unit, using a hard shrink free dental sticky wax plasticised by heat between the ridge-lap base of the lower denture teeth unit and on or before the course of the crest of the base of the lower bite recording block;
12. contouring the base of the lower bite block, initially made as a final plastic denture base, thereby substantially in a shape sufficient stable in the mouth, hereto using hard dental modelling wax;
13. removing the occlusal guide from the upper tray member and releasable-fixing the previously removed upper jaw model, initially mounted with the upper bite block in the centric occlusal stand and without the wax bite occlusal rim, on the vacant upper tray member;
14. from the provision, using and setting-up the complete arched upper denture teeth unit, with the occlusal bite-plane in centric occlusal stand, either with a full or partly occlusal contact on the occlusal bite plane of the lower denture teeth unit; hereto
having the occlusal upper bite plane either in a planar or curved form conformed to the occlusal bite plane form of the lower denture teeth unit defined and used either planar or curved during the setting-up of the lower denture teeth unit; thereby
having the unitary ridge-lap base of the upper denture teeth unit adapted at least at a distance of 0.5 mm. from or before the course of the crest of the base of the upper recording bite block mounted on the upper jaw model fixed on the upper tray member of the articulator; thereby
having the distal proximal surface of the left and right end of the upper denture teeth unit respectively anterior to the region of the right and left end of the upper bite recording block base covering the corresponding left and right tuberosity region, including any incline of the alveolar ridge anterior to the tuberosities respectively marked on the bite block base, of the upper jaw model; simultaneously
setting the upper anterior denture teeth either edge-to-edge or with a extra horizontal over-jet of two to three mm. relatively to the incisal edges of the lower anterior denture teeth; further
15: fixing the setting-up of the arched upper denture teeth unit hereto using hard shrink-free dental sticky wax plasticised by heat between the ridge-lap base of the upper denture teeth unit and on or before the course of the crest of the base of the upper recording block;
16. adjusting the inter-occlusal bite-plane of the upper and lower denture teeth unit for a total even centric occlusal contact and non-interfering eccentric bi-lateral and protrusive balanced articular contact; hereto
using rotary gliding movements with the universal balance articulator used from the provision dental aids; thereby
in the case of a curved inter-occlusal bite plane, established with the curved sphero-ellipsoidal occlusal guide plate, releasing the bolt-nut of the fixed curved articular joint devised on the lower articulator member; thereby
applying the jaw movements, by sliding the upper curved articular block on the lower curved articular block either forward-backward or bi-lateral left and right;
in the case of a planar inter-occlusal bite plane, established with a planar occlusal guide plate releasing the bolt-nut of the fixed planar articular joint, located at the mid height of the articulator base; thereby
applying the jaw movements using similar sliding technique as defined for the curved articular joint, by using the upper planar articular block on the lower planar articular block;
adjusting either of the inter-occlusal bite planes by removing any interfering centric and eccentric articular contacts which are removed by established dental spot-grinding articular procedures either with blue articulating paper or coloured powder or liquids;
17: using hard dental modelling wax, contouring the upper bite block base, made initially as a basic upper denture base of plastic, made orally stable with an orally non-interfering and retentive basal seat.

20: A method as claimed in claim 10 or 19, in which the universal balance; dental articulator is a customised simplified setting-up tool characterized by an ability for creating a individual full balanced articulation for complete custom dentures, by exploiting the physiological flexibility of the temporo-mandibular joint of the individual human jaw complex, and with the use of the setting-up the combination complete set(s) of denture teeth either separated one by one or interconnected in a fully complete or under-extended complete arch form including the free centric occlusion and the eccentric full balanced protrusive bi-lateral articulation.

21: A method as claimed in claim 19 or 20, in which the universal balance articulator is substantially made of anodised aluminium or engineering plastics including a internal height at least of 110 mm. predetermined to be suitable to accommodate the jaw model complex in centric occlusion with the use of the orally recorded bite-block complex substantially as an assembly predetermined about 80 mm. in height, as well as to accommodate the setting-up of the combination set(s) complete arched denture teeth upper and lower units in an instant and adjustable full balanced articulation; having the articulator further characterized with an articular joint structure including a combination of two articular joints which are parallel and horizontal with each other thereby composed:
firstly with a releasable-fixing horizontal planar articular joint devised with an upper and lower complementary planar articular block fixed together, but releasable, with a bolt-nut device; thereby having the upper articular block further devised in conjunction with a hinged laterally and horizontally extended upper tray member; thereby having the articular joint substantially as an integrated part at mid of the internal height 110 mm. of the articulator,
secondly a releasable-fixing curved articular joint of a sphero-ellipsoidal cross section conformed to a least 4 inch (11 cm) radius of a sphere; having the curved articular joint devised initially with a curved sphero-ellipsoidal lower articular block, preformed either from metal or engineering plastic or stone conformed and fixed but releasable with a cross pin on the lower tray member and parallel with the upper tray member; thereby having the initial curved lower articular block further devised with a curved complementary upper articular block during the fixings of the upper and lower jaw model complex, recorded in centric occlusion with the orally registered bite-block complex on the tray members of the articulator; thereby leaving the curved sphero-ellipsoidal upper articular block custom formed from stone conformed between the base of the lower jaw model and the initial preformed curved lower articular block and having both blocks fixed together, but releasable, with a releasable fixing bolt-nut device on the lower tray member.

22: A method as claimed in claim 20 or 21, in which the combination of the curved and planar articular joint of the universal balance dental articulator is characterized by a design form substantially suitable to execute movements such as gliding and rotating of the human temporo-mandibular joint which includes the sufficient flexibility to render the capability, either for the planar or curved articular joint of the articulator during the establishment of the balanced articulation of the combination set(s), to imitate and execute the movements of the individual condyle path movements during the establishment of the balanced articulation.

23: A method as claimed in claim 21 or 22, in which the horizontal articular joint of the universal balance dental articulator, includes a triple function predetermined for control of the exact closure of the articulator, whereby the planar articular blocks (27, 28) of the horizontal articular joint are meeting each other in a planar level: firstly during and for the establishment of the curved custom formed articular block of the curved articular joint; secondly for and during the establishment of the upper and lower jaw model complex in centric occlusion by use of the orally registered bite-block complex on the articulator; thirdly for and during the checking and adjustment for the establishment of a non-interfering centric occlusion, and full balanced articulation thereof for either of the setting ups of the combination set(s) of denture teeth characterised with a planar or a curved inter-occlusal bite-plane and achieved on the universal balance dental articulator.

24: A method as claimed in claim 23, in which the centric occlusion and balanced articulation, of the setting-ups of the combination complete set(s) denture teeth either separated or interconnected in arch form, are respectively an exact free centric occlusion and a free eccentric non-interfering protrusive and bi-lateral individual full balanced articulation, hereto having the complete set(s) denture teeth composed of anterior and posterior denture teeth wherein the posterior denture teeth are occlusally cuspless and sphero ellipsoidal, conformed to a 4 inch (11 cm) radius of a sphere as well as conformed to a buccal-lingual and buccal-palatal width, non interfering to the tongue and sufficient to accommodate an individual articular balance contact of denture teeth.

25: A method of claim 10 or 19, in which the telescopic occlusal guide is a customised tool devised from anodised or engineering plastics, complementary to the universal balance dental articulator, thereby devised for guiding and forming the setting-ups of the complete combination set(s) denture teeth, either with a planar or curved inter-occlusal bite plane, in the full balanced articulation; thereby having the occlusal guide characterized by a base predesignated to be fitted and suspended releasable-fixing into the upper articulator tray member of the articulator; the base is devised with a vertically adjustable telescopic sliding arbor substantially of a non-rotative cross-section and at least in an arbor length of 40 mm. and 70 mm., suitable measurements to accommodate the telescopic occlusal guide to the internal height of the universal dental balance articulator for its use with the articulator; having either of the arbor lengths with the upper end fitted and fixed but releasable into the base of the occlusal guide and with the lower end fitted and fixed releasable either onto the planar or curved sphero-ellipsoidal occlusal guide plate; (conformed at least to a 4 inch (11 cm) radius, of a sphere.

26: A method as claimed in claim 19 or 25, in which the vertically adjustable telescopic arbor, including the arbor length of 40 mm., is substantially a component complementary to the telescopic occlusal guide, predesignated to coordinate releasable fixing either the planar or curved occlusal guide plate to the occlusal guide on the articulator, thereby characterized in that the arbor length accommodates the occlusal guide to the internal height of 110 mm. of the articulator for forming an individual sphero-ellipsoidal inter-occlusal bite plane either in a planar or curved level during the setting-up of the combination set(s) denture teeth either separated or interconnected in a fully complete or under extended complete arch form.

27: A method as claimed in claim 19 or 26, in which the arbor of 40 mm. is further characterized in that the arbor is vertically adjustable, to suspend, position and hold either of the occlusal guide plates on the occlusal guide vertically fixed on the articulator, having the plates in a similar position, parallel and horizontally levelled with the curved articular joint of the articulator, thereby at a suitable overhead distance from the lower jaw model fixed, but releasable, either on the lower tray member or on the lower articular joint of the articulator; having the overhead distance substantially to accommodate a sufficient free way space for setting-up the lower denture teeth of the combination sets(s) either separated one by one or interconnected in a fully complete or under-extended complete arch form.

28: A method of claim 18 or 27, in which the suitable overhead distance is the distance which renders the capability to fit with ease the lower denture teeth of the combination set(s) either separate or interconnected in a fully complete or under extended complete arch form, thereby in a manner whereby the base (ridge lap) of the denture teeth is freely adaptable including at least 0.5 mm. on or before the crest of the base of the lower bite-block, without its wax occlusal bite rim, simultaneously having the ends of the last left and right posterior denture tooth of the set of lower denture teeth respectively anterior to the left and right region of the base of the lower bite recording block covering the left and right retromolar pad region, including any incline of the alveolar ridge anterior to the pads, of the lower plaster jaw model covered with the base of the lower bite-block; simultaneously having the inter-occlusal bite plane of the lower set denture teeth in exact fit to the under surface of the suitable either curved or planar occlusal guide plate to be suspended at the suitable overhead distance rendering a sufficient free way space.

29: A method as claimed in claim 21 or 25, in which the arbor of 70 mm. length is substantial an auxiliary component complementary to the telescopic occlusal guide predetermined to coordinate releasable-fixing only the curved occlusal guide plate to the telescopic occlusal guide on the articulator, thereby characterised in that the arbor length 70 mm. accommodates the internal height of 110 mm. of the articulator for the establishment of the curved lower sphero-ellipsoidal articular block of the curved sphero-ellipsoidal articular joint of the articulator.

30: A method as claimed in claim for 18, in which the combination set(s) arched upper and lower denture teeth units preformed in a fully complete or under-extended complete arch form, enables a manner of setting-up the combination set(s) denture teeth in an instant, exact, and full (bi-lateral and protrusive) balanced articulation during custom denture work including either a complete (upper and lower) denture or complete over-denture or complete implant denture or a complete over-denture or a partial (upper and lower) bi-lateral free-end denture.

31: A combination set of complete arched denture teeth units upper and lower without denture base as herein described in the specification with reference to any one or more of the accompanying drawings.
